(19) United States
(12) Patent Application Publication
(10) Pub. No.: US 2009/0012203 A1
(43) Pub. Date: Jan. 8, 2009

(54) Epoxy Resin and Epoxy Resin Composition

(75) Inventors: Masataka Nakanishi, Tokyo (JP); Ryutaro Tanaka, Tokyo (JP)

Correspondence Address: Nields & Lemack, 176 E. Main Street, Suite #5, Westboro, MA, 01581, US

(73) Assignee: NIPPON KAYAKU KABUSHIKI KAISHA, Tokyo (JP)

(21) Appl. No.: 11/918,976

(22) PCT Filed: Apr. 28, 2006
(86) PCT No.: PCT/JP2006/308959

§ 371 Date: Jan. 18, 2008

(30) Foreign Application Priority Data
Apr. 28, 2005 (JP) 2005-131463

(51) Int. Cl. C08L 63/10; C08G 59/06; C08L 63/00

(52) U.S. Cl. 522/135; 528/87; 525/523

(57) ABSTRACT

[PROBLEMS] The present invention relates to a crystalline epoxy resin, which gives a cured object excellent in various properties including flame retardancy, low water absorption, and impact resistance. The object of the present invention is to provide epoxy resin which is useful as an optical material, an epoxy resin composition containing crystals of the epoxy resin having excellent storage stability and a cured object obtained from the composition.
[MEANS FOR SOLVING PROBLEMS] The crystalline epoxy resin obtained by the glycidylation of the compound represented by the following formula (1).

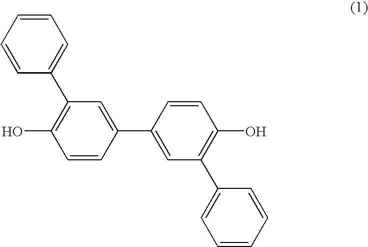

### TECHNICAL FIELD

The present invention relates to a crystalline epoxy resin and an epoxy resin composition for optical using the same.

### BACKGROUND ART

Epoxy resins are cured by various curing agents into cured products, generally excellent in mechanical properties, water resistance, chemical resistance, heat resistance and electric properties. Such products are used in wide fields including adhesives, coatings, laminated boards, molded materials and cast materials. As the form of epoxy resins, epoxy resins in the form of liquid at room temperature and epoxy resins having a softening point of 50 to 100° C. are generally used. Recently, properties of these materials, such as high purity, heat resistance, moisture resistance, adhesiveness, low dielectric properties, rapid curing properties, flame retardancy and high toughness, are required to be further improved. In particular, since halogen-free flame retardancy is recently required, flame retardancy of resins themselves is strongly needed. Particularly, it is reported that epoxy resins with this skeleton are excellent in various properties such as flame retardancy, low water absorbing properties and impact resistance (Patent Documents 1, 2).

Also, resins with a high refractive index are widely used in the field of optical materials, for example, plastic materials such as contact lenses, glass lenses and camera lenses, prisms, filters, image display materials, light guides and optical disk substrates, in the field of molding such as packaging containers for creating appearance, casing materials, films, general goods and molding fields of automobile parts, and in the field of coating materials. Although vinyl copolymers such as polystyrene or polymethyl methacrylate are used in such fields, their reliability is insufficient in the fields where heat resistance is required. Under the present circumstances, studies are underway for applying epoxy resins which provide cured products with highly reliable heat resistance and hygroscopic properties to the field of optical materials. However, most of polycyclic aromatic epoxy resins with such properties are colored and have a refractive index of 1.6 or less, and are not satisfactory in the field where a high refractive index is required.

Besides, photosensitive resin compositions are recently frequently used because of their simple curing conditions and workability. However, curing simply with light cannot achieve high reliability required for electric and electronic materials because the resultant has low moisture resistance and low heat resistance, and so photocurable thermosetting resins are recently particularly attracting attention. For example, in the field of solder resist, filling ink, overcoat and various adhesives, epoxy resin compositions prepared by adding an epoxy resin to the ingredients, primarily curing by light and then secondarily curing by heating are now being used. In such fields, preservation (storage) stability of epoxy resins through secondary curing is important. Under such circumstances, crystalline epoxy resins excellent in heat stability are attracting attention.

Although TEPIC series (available from Nissan Chemical Industries, heterocycle-containing crystalline epoxy resin) are generally used as such epoxy resins, epoxy resins alternative to these resins are now being studied because of a problem of water (moisture) of TEPIC.

Patent Document 1: Japanese Patent Application Laying Open (KOKAI) No. 09-157351

Patent Document 2: Japanese Patent Application Laying Open (KOKAI) No. 2000-248050

### DISCLOSURE OF THE INVENTION

### Problems to be Solved by the Invention

The present invention relates to a crystalline epoxy resin. An object of the present invention is to provide an epoxy resin excellent in various properties such as flame retardancy, low water absorbing properties, impact resistance and refractive index and useful as an optical material in the form of a cured product, an epoxy resin composition containing the epoxy resin crystal excellent in storage (preservation) stability and a cured product thereof.

### Means to Solve the Problem

The present inventors have conducted intensive studies on epoxy resins having properties described above and completed the present invention.

Accordingly, the present invention relates to a crystalline epoxy resin obtained by reacting a compound represented by the following formula (1):

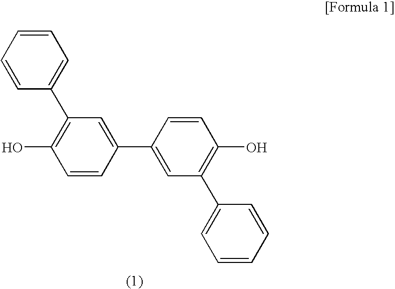

and epihalohydrin;

(2) an epoxy resin composition comprising the epoxy resin according to the above (1) and a curing agent;

(3) an epoxy resin composition comprising the epoxy resin according to (1), a compound containing one or more unsaturated double bonds in the molecule and a photopolymerization initiator;

(4) a cured product of the epoxy resin composition according to the above (2) or (3); and

(5) an optical material using the epoxy resin composition according to the above (2) or (3).

### EFFECTS OF THE INVENTION

Since the epoxy resin of the present invention is crystalline, has a significantly high refractive index and is colorless, said epoxy resin is suitable for optical uses. Since the epoxy resin composition and the cured product of the present invention have good stability when epoxy resin is photo-cured, the epoxy resin composition have excellent heat stability and highly sensitive. Besides, when the epoxy resin of the present invention is used as a component of a thermosetting epoxy resin composition or a photocurable thermosetting resin composition, the composition has a vastly superior storage stability. Accordingly, the epoxy resin composition of the present invention is very useful in a wide range of applications such as electric and electronic materials, molding materials, casting materials, laminate materials, coatings, adhesives, resists and optical materials.

### BEST MODE FOR CARRYING OUT THE INVENTION

The epoxy resin of the present invention can be obtained in the form of crystal by reacting a phenol resin represented by the following formula (1):

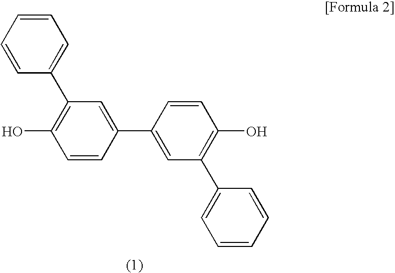

and epihalohydrin in the presence of alkali metal hydroxide, followed by crystallizing.

In the reaction of preparing the epoxy resin of the present invention, alkali metal hydroxide may be used in the form of solid or an aqueous solution. When using an aqueous solution thereof, a method may be employed, in which an aqueous solution of an alkali metal hydroxide is continuously added to the reaction system and at the same time, water and epihalohydrin are continuously discharged under reduced pressure or normal pressure, and further, separation is performed to remove water and continuously return epihalohydrin to the reaction system. Usually 0.9 to 2.5 moles, preferably 0.95 to 2.0 moles of an alkali metal hydroxide is used based on 1 mole of hydroxyl groups of the compound represented by the formula (1).

In the reaction, a quaternary ammonium salt may be added as a catalyst for easy progress of the reaction. Examples of applicable quaternary ammonium salts include tetramethylammonium chloride, tetramethylammonium bromide, trimethylbenzyl ammonium chloride and the like. Generally 0.1 to 15 parts by weight, preferably 0.2 to 10 parts by weight of a quaternary ammonium salt is used based on 1 mole of hydroxyl groups of the compound represented by the formula (1).

Generally 0.8 to 12 moles, preferably 0.9 to 11 moles of epihalohydrin is used based on 1 mole of hydroxyl groups of the compound represented by the formula (1). As epihalohydrin, epichlorohydrin derivatives such as epichlorohydrin, α-methylepichlorohydrin, β-methylepichlorohydrin and γ-methylepichlorohydrin, preferably epichlorohydrin, are industrially useful. At this stage, to improve the solubility of the compound represented by the formula (1), alcohol such as methanol, ethanol or isopropyl alcohol or an aprotic solvent such as dimethyl sulfone, dimethyl sulfoxide, tetrahydrofuran or dioxane is preferably added when performing the reaction.

When using alcohol, generally 2 to 50% by weight, preferably 4 to 30% by weight of the alcohol is used based on the amount of epihalohydrin. When using an aprotic polar solvent, generally 5 to 100% by weight, preferably 10 to 80% by weight of the aprotic polar solvent is used based on the amount of epihalohydrin.

The reaction temperature is generally 30 to 90° C., preferably 35 to 80° C. The temperature may be constant or changed with time. The reaction time is generally 0.5 to 10 hours, preferably 1 to 8 hours. Further, if necessary, to prepare an epoxy resin containing hydrolyzable halogen in a smaller amount, epihalohydrin, the solvent and the like are removed from the reactant of the epoxidation reaction after water washing or while heating under reduced pressure without water washing. The recovered epoxy resin may be dissolved in a solvent such as toluene or methyl isobutyl ketone and reacted by adding an aqueous solution of an alkali metal hydroxide such as sodium hydroxide or potassium hydroxide to ensure ring closure. In that case, generally 0.01 to 0.3 mole, preferably 0.05 to 0.2 mole of alkali metal hydroxide is used based on 1 equivalent of hydroxyl groups of the compound used for epoxidation shown in Table 1. The reaction temperature is generally 50 to 120° C. The reaction time is generally 0.5 to 2 hours.

After completion of the reaction, the reaction solution is washed with water or filtered to remove salt or impurities generated during the reaction. This procedure is important because salt may be included in crystal when the epoxy resin is precipitated.

The method of crystallization of an intended epoxy resin from the resulting reaction solution containing the epoxy resin is not particularly limited. Various methods may be used in which the reaction solution is once concentrated and then recrystallization is performed using a solvent or in which a poor solvent is added and then reprecipitation is performed. However, in the present invention, the following method is preferred.

A reaction mixture containing the reaction product, epihalohydrin and the like is heated under reduced pressure and excess epihalohydrin and the like are removed (step (a); epihalohydrin recovery step). In this step, recovery under reduced pressure is stopped when crystal is precipitated and a slurry is formed, and after adding an organic solvent, for example, ketone such as acetone, methyl ethyl ketone (MEK), cyclopentanone (CP) or anone, ester such as ethyl acetate, butyl acetate, ethyl butyrate, γ-butyrolactone or carbitol acetate, ether such as dioxane or tetrahydrofuran (THF), or alcohol such as methanol, ethanol, propanol, butanol, ethylene glycol or propylene glycol and dispersing the solvent (step (b): crystallization step 1), a water-soluble solvent, for example, alcohol such as methanol, ethanol, propanol, butanol, ethylene glycol or propylene glycol or ketone such as acetone is further added, if necessary (step (b′): crystallization step 2), and water is gradually added dropwise thereto (step (c): crystallization step 3). Subsequently, the resulting crystal is filtered off and dried (step (d): drying step) to give the intended crystalline epoxy resin.

Conditions and the amount of the solvent in the aforementioned steps cannot be generally determined because they vary depending on the solvent to be used. In an example using epichlorohydrin as epihalohydrin in step (a), acetone in step (b) and methanol in step (b′), heating may be performed to 50 to 100° C. at a vacuum degree of about −0.05 MPa to −0.095 MPa in step (a). The amount of acetone used in step (b) is preferably 20 to 500% by weight, particularly preferably 50 to 200% by weight based on the theoretical yield. The amount of methanol used in step (b′) is preferably 20 to 500% by weight, particularly preferably 50 to 200% by weight based on the theoretical yield. Also, while the amount of water used in step (c) is preferably 40 to 1000% by weight in that case, water is preferably used at a ratio of the solvent in step (b): step (b′): step (c) to water of about 1 to 3:1 to 3:1 to 9. Preferably, the crystal filtered off in step (e) is washed with alcohol such as methanol or ethanol or water.

The epoxy resin prepared as described above is colorless and has a melting point of about 100° C. Accordingly, even when the epoxy resin is dispersed in a photocurable resin composition, the resulting epoxy resin composition has excellent storage stability. Besides, the refractive index of the obtained epoxy resin indicates 1.65 to 1.66. A typical aromatic epoxy resin, for example, a cresol novolac epoxy resin, has a refractive index of about 1.60. Even a biphenyl novolac epoxy resin which has a relatively high refractive index has a refractive index of about 1.62, and a bisphenol fluorene epoxy resin has a refractive index of about 1.63. Although depending on the curing agent, these epoxy resins have increased molecular density due to curing reaction, and therefore a cured product having a higher refractive index can be prepared. Accordingly, the present colorless compound having a high refractive index is suitable for optical materials.

In the following, the epoxy resin composition of the present invention is described. The epoxy resin composition of the present invention contains the epoxy resin of the present invention and a curing agent. In the epoxy resin composition of the present invention, the epoxy resin of the present invention may be used alone or in combination with another epoxy resin. While an epoxy resin generally used can be used as another epoxy resin without limitation, a crystalline epoxy resin having a softening point or a melting point of 90° C. or higher is preferred. When the epoxy resin of the present invention and another epoxy resin are used in combination, the mixing ratio may be optionally changed.

Specific examples of another epoxy resins that can be preferably used in combination include biphenol or biphenol crystalline epoxy resins or mixtures thereof such as YX-4000 available from Japan Epoxy Resins and CER-3000 available from NIPPON KAYAKU CO., LTD. (trade names); bisphenol S crystalline epoxy resins; bisphenol fluorene crystalline epoxy resins; hydroquinone crystalline epoxy resins; heterocyclic crystalline epoxy resins such as TEPIC (trade name) available from NISSAN CHEMICAL INDUSTRIES, LTD., crystalline epoxy resins of glyoxal-phenol condensate, trisphenolmethane crystalline epoxy resins and biphenyl novolak crystalline epoxy resins (e.g., crystalline epoxy resins having a skeleton similar to that of NC-3000 available from NIPPON KAYAKU CO., LTD.). These may be used alone or in combination of two or more.

Examples of curing agents for an epoxy resin contained in the thermosetting epoxy resin composition of the present invention include amine compounds, acid anhydride compounds, amide compounds and phenol compounds. Specific examples of applicable curing agents include, but not limited to, diaminodiphenylmethane, diethylenetriamine, triethylenetetramine, diaminodiphenylsulfone, isophoronediamine, dicyandiamide, polyamide resins synthesized from a dimer of linolenic acid and ethylenediamine, phthalic anhydride, trimellitic anhydride, pyromellitic dianhydride, maleic anhydride, tetrahydrophthalic anhydride, methyltetrahydrophthalic anhydride, methyl nadic anhydride, hexahydrophthalic anhydride, methylhexahydrophthalic anhydride, bisphenol A, bisphenol F, bisphenol S, fluorene bisphenol, terpene diphenol, 4,4′-biphenol, 2,2′-biphenol, 3,3′,5,5′-tetramethyl-[1,1′-biphenyl]-4,4′-diol, hydroquinone, resorcin, naphthalenediol, tris-(4-hydroxyphenyl)methane, 1,1,2,2-tetrakis(4-hydroxyphenyl)ethane, polycondensate of phenol (phenol, alkyl-substituted phenol, naphthol, alkyl-substituted naphthol, dihydroxybenzene, dihydroxynaphthalene and the like) and formaldehyde, acetaldehyde, benzaldehyde, p-hydroxybenzaldehyde, o-hydroxybenzaldehyde, p-hydroxyacetophenone, o-hydroxyacetophenone, dicyclopentadiene, furfural, 4,4′-bis(chloromethyl)-1,1′-biphenyl, 4,4-bis(methoxymethyl)-1,1′-biphenyl, 1,4-bis(chloromethyl)benzene or 1,4-bis(methoxymethyl)benzene and modified products thereof, halogenated bisphenols such as tetrabromobisphenol A, imidazoles, BF₃-amine complexes and guanidine derivatives. These may be used alone or in combination of two or more.

In the epoxy resin composition of the present invention, the amount of the curing agent is preferably 0.5 to 2.0 equivalents, particularly preferably 0.6 to 1.5 equivalents based on 1 equivalent of epoxy groups of all the epoxy resin components including the epoxy resin of the present invention. When the amount is less than 0.5 equivalent or more than 2.0 equivalents based on 1 equivalent of epoxy groups, curing would not be complete and good curing properties may not be achieved.

When using the above curing agent, a curing accelerator may be used. Examples of applicable curing accelerators include imidazoles such as 2-methylimidazole, 2-ethylimidazole, 2-phenylimidazole and 2-ethyl-4-methylimidazole, tertiary amines such as 2-(dimethylaminomethyl)phenol, triethylenediamine, triethanolamine and 1,8-diazabicyclo(5,4,0)undecene-7, organic phosphines such as triphenylphosphine, diphenylphosphine and tributylphosphine, metal compounds such as tin octylate, tetra-substituted phosphonium-tetra-substituted borate such as tetraphenylphosphonium-tetraphenylborate and tetraphenylphosphonium.ethyltriphenylborate and tetraphenylboron salts such as 2-ethyl-4-methylimidazole.tetraphenylborate and N-methylmorpholine.tetraphenylborate. When the curing accelerator is used, the amount of the curing accelerator is 0.01 to 15 parts by weight based on 100 parts by weight of the epoxy resin according to need.

Further, various compounding agents such as inorganic fillers, silane coupling agents, release agents and pigments and various thermosetting resins may be added, if necessary, to the epoxy resin composition of the present invention. Examples of inorganic fillers include, but not limited to, crystalline silica, molten silica, powder of alumina, zircon, calcium silicate, calcium carbonate, silicon carbide, silicon nitride, boron nitride, zirconia, forsterite, steatite, spinel, titania or talc or beads prepared by making such powder spherical. These may be used alone or in combination of two or more.

The inorganic filler is used preferably in a proportion of 80 to 93% by weight based on the epoxy resin composition when preparing, in particular, an epoxy resin composition for a semiconductor sealing material in consideration of heat resistance, moisture resistance and mechanical properties of a cured product.

The epoxy resin composition of the present invention is prepared by homogeneously mixing the above components. The epoxy resin composition is preferably used as a semiconductor sealing material. The modified epoxy resin composition of the present invention is easily formed into a cured product by a method similar to a conventionally known method. For example, the modified epoxy resin of the present invention, a curing agent, and if necessary, a curing accelerator, an inorganic filler, a compounding agent and various thermosetting resins are sufficiently mixed until homogeneous using an extruder, a kneader or a roll, if necessary, thereby preparing the epoxy resin composition of the present invention, and the epoxy resin composition is molded by melt casting, transfer molding, injection molding or press molding, and further heated at the melting point or higher of the epoxy resin for 2 to 10 hours to give the cured product of the present invention.

Besides, a cured product can be prepared by dissolving the epoxy resin composition of the present invention in a solvent such as toluene, xylene, acetone, methyl ethyl ketone or methyl isobutyl ketone and molding, by a heat press, a prepreg obtained by impregnating a substrate such as glass fiber, carbon fiber, polyester fiber, polyamide fiber, alumina fiber or paper followed by heating and drying.

Generally 10 to 70% by weight, preferably 15 to 65% by weight of a diluting solvent is used at that stage based on the total weight of the modified epoxy resin composition of the present invention and the diluting solvent.

Examples of semiconductor devices for which the epoxy resin composition of the present invention is preferably used include DIP (dual inline package), QFP (quad flat package), BGA (ball grid array), CSP (chip size package), SOP (small outline package), TSOP (thin small outline package) and TQFP (thin quad flat package). Since the epoxy resin of the present invention has little color and excellent light transmittance, the epoxy resin can be used in an optical semiconductor sealing device. For example, the epoxy resin composition of the present invention can also be used for sealing of photosemiconductor elements (semiconductor chips) such as light emitting diodes (LED), phototransistors, CCDs (charged coupled devices) and EPROMs such as UV-EPROMs.

The epoxy resin of the present invention can also be used for a photosensitive epoxy resin composition. Specifically, the epoxy resin of the present invention can be used as a curing agent for improving reliability of an epoxy resin composition.

A typical photosensitive epoxy resin composition can be prepared, for example, by adding the epoxy resin of the present invention as one component of curing agent (D) to a photosensitive resin comprising an alkaline aqueous solution soluble resin (A), a crosslinking agent (B), a photopolymerization initiator (C) and a curing agent (D). The content of the epoxy resin is 1 to 50% by weight, preferably 2 to 30% by weight.

Details of the components are as described below. Although specific examples are described, the respective materials used for the epoxy resin composition of the present invention are not limited to the compounds described.

Alkaline Aqueous Solution Soluble Resin (A):

Examples thereof include reaction products of an epoxy carboxylate compound prepared by reacting an epoxy compound (a) having two or more epoxy groups in the molecule and a monocarboxylic acid compound (b) containing an ethylenically unsaturated group in the molecule with polybasic acid anhydride (c). Specific examples thereof include KAYARAD CCR-1159H, KAYARAD PCR-1169H, KAYARAD TCR-1310H, KAYARAD ZFR-1401H and KAYARAD ZAR-1395H (all available from NIPPON KAYAKU CO. LTD.).

Crosslinking Agent (B):

Examples thereof include compounds having an ethylenically unsaturated group, such as acrylate or methacrylate compounds. Specific examples thereof include KAYARAD HX-220, KAYARAD HX-620 and KAYARAD DPHA, KAYARAD DPCA-60 (all available from NIPPON KAYAKU CO. LTD.).

Photopolymerization Initiator (C):

Examples thereof include benzoin, acetophenone, anthraquinone, thioxanthone, ketal, benzophenone and phosphine oxide. Specific examples thereof include KAYACURE DETX-S (available from NIPPON KAYAKU CO. LTD.) and IRGACURE 907 (CIBA SPECIALTY CHEMICALS).

Curing Agent (D):

The curing agent is not particularly limited as long as the compound has two or more epoxy groups. The epoxy resin of the present invention is preferably 30% by weight or more, more preferably 50 to 100% by weight based on all the curing agents. Specific examples of epoxy resins that can be used in combination with the epoxy resin of the present invention include the following phenol novolak epoxy resins, cresol novolak epoxy resins, trishydroxyphenylmethane epoxy resins, dicyclopentadiene phenol epoxy resins, bisphenol A epoxy resins, bisphenol F epoxy resins, biphenol epoxy resins, bisphenol A novolak epoxy resins, naphthalene skeleton-containing epoxy resins and heterocyclic epoxy resins.

Phenol Novolak Epoxy Resin:

e.g., EPICLON N-770 (available from Dainippon Ink & Chemicals Incorporated), D.E.N438 (available from The Dow Chemical Company), EPICOAT 154 (available from Japan Epoxy Resins), RE-306 (available from NIPPON KAYAKU CO., LTD.)

Cresol Novolak Epoxy Resin:

e.g., EPICLON N-695 (available from Dainippon Ink & Chemicals Incorporated), EOCN-102S, EOCN-103S, EOCN-104S (all available from NIPPON KAYAKU CO., LTD.), UVR-6650 (available from Union Carbide Corporation), ESCN-195 (available from Sumitomo Chemical Co., Ltd.)

Bisphenol A Novolak Epoxy Resin:

e.g., EPICLON N-880 (available from Dainippon Ink & Chemicals Incorporated), EPICOAT E157S75 (available from Japan Epoxy Resins)

Trishydroxyphenylmethane Epoxy Resin:

e.g., EPPN-503, EPPN-502H, EPPN-501H (all available from NIPPON KAYAKU CO., LTD.), TACTIX-742 (available from The Dow Chemical Company), EPICOAT E1032H60 (available from Japan Epoxy Resins)

Dicyclopentadiene Phenol Epoxy Resin:

e.g. EPICLON EXA-7200 (available from Dainippon Ink & Chemicals Incorporated), TACTIX-556 (available from The Dow Chemical Company)

Bisphenol Epoxy Resin:

e.g., bisphenol A epoxy resins such as EPICOAT 828, EPICOAT 1001 (both available from Japan Epoxy Resins), UVR-6410 (available from Union Carbide Corporation), D.E.R-331 (available from The Dow Chemical Company), YD-8125 (Tohto Kasei Co., Ltd.); bisphenol F epoxy resins such as UVR-6490 (available from Union Carbide Corporation), YDF-8170 (available from Tohto Kasei Co., Ltd.)

Biphenol Epoxy Resin:

e.g., biphenol epoxy resins such as NC-3000, NC-3000H (both available from NIPPON KAYAKU CO., LTD.), biphenol epoxy resins such as YX-4000 (available from Japan Epoxy Resins), YL-6121 (available from Japan Epoxy Resins)

Naphthalene Skeleton-Containing Epoxy Resin:

e.g., NC-7000, NC-7300 (both available from NIPPON KAYAKU CO., LTD.), EXA-4750 (available from Dainippon Ink & Chemicals Incorporated)

Alicyclic Epoxy Resin:

e.g., EHPE-3150 (available from DAICEL CHEMICAL INDUSTRIES, LTD.)

Heterocyclic Epoxy Resin:

e.g., TEPIC-L, TEPIC-H, TEPIC-S (all available from Nissan Chemical Industries)

Further, if necessary, various additives, for example, fillers such as talc, barium sulfate, aluminum hydroxide, aluminum oxide, silica and clay, thixotropy imparting agents such as aerosil, colorants such as phthalocyanine blue, phthalocyanine green and titanium oxide, leveling agents and defoaming agents such as silicone and fluorine; and polymerization inhibitors such as hydroquinone and hydroquinone monomethyl ether can be added in order to improve various properties of the composition.

The epoxy resin composition of the present invention may contain a solvent, if necessary. Examples of applicable solvents include ketones such as acetone, ethyl methyl ketone and cyclohexanone, aromatic hydrocarbons such as benzene, toluene, xylene, tetramethylbenzene, glycol ethers such as ethylene glycol dimethyl ether, ethylene glycol diethyl ether, dipropylene glycol dimethyl ether, dipropylene glycol diethyl ether, triethylene glycol dimethyl ether and triethylene glycol diethyl ether, esters such as ethyl acetate, butyl acetate, methyl cellosolve acetate, ethyl cellosolve acetate, butyl cellosolve acetate, carbitol acetate, propylene glycol monomethyl ether acetate, glutaric acid dialkyl, succinic acid dialkyl and adipic acid dialkyl, cyclic esters such as γ-butyrolactone and petroleum solvents such as petroleum ether, petroleum naphtha, hydrogenated petroleum naphtha and solvent naphtha. These may be used alone or in combination of two or more.

The epoxy resin composition (liquid or film) of the present invention can be used as an interlayer insulating material of electronic parts, an optical waveguide connecting optical parts, a resist material such as a solder resist or a cover lay for a printed board. Further, it can be used as a color filter, printing ink, a sealing agent, a coating, a coating agent, an adhesive and the like.

The cured product of the present invention is prepared by curing the above-described epoxy resin composition of the present invention by irradiation of energy rays such as ultraviolet rays. Curing by irradiation of energy rays such as ultraviolet rays can be performed by a usual method. When using, for example, ultraviolet rays, a ultraviolet ray generator such as a low-pressure mercury lamp, a high-pressure mercury lamp, a ultra-high pressure mercury lamp, a xenon lamp or a ultraviolet ray emitting laser (excimer laser) may be used.

The cured product of the photosensitive epoxy resin composition of the present invention is used, for example, as a resist film, an interlayer insulating material in a build-up process or an optical waveguide in an electric, electronic or optical substrate material such as a printed board, a photoelectronic substrate or an optical substrate. Specific embodiments thereof include products such as computers, home electric appliances and portable devices. The cured product layer has a film thickness of about 0.5 to 160 μm, preferably about 1 to 100 μm.

When manufacturing, for example, a printed wiring board, the printed wiring board can be manufactured as follows. Specifically, when using the resin composition of the present invention in the form of liquid, the composition is applied to a printed wiring board by screen printing, spraying, roll coating, electrostatic coating, curtain coating or the like in a film thickness of 5 to 160 μm and the coating film is dried at a temperature of generally 50 to 110° C., preferably 60 to 100° C. After that, the coating film is irradiated with high energy rays such as ultraviolet rays directly or indirectly through a photomask on which an exposure pattern is formed, such as a negative film, at an intensity of generally about 10 to 2000 mJ/cm². Then, unexposed portions are developed by spraying, dipping and shaking, brushing or scrapping using a developer described below. Subsequently, the resultant is further irradiated with ultraviolet rays, if necessary, and heated at a temperature of generally 100 to 200° C., preferably 140 to 180° C. to give a printed wiring board with a permanent protective film, excellent in gold plating properties and satisfying various properties such as heat resistance, solvent resistance, acid resistance, adhesiveness and flexibility.

As the alkaline aqueous solution used for development, an inorganic alkaline aqueous solution such as potassium hydroxide, sodium hydroxide, sodium carbonate, potassium carbonate, sodium bicarbonate, potassium bicarbonate, sodium phosphate or potassium phosphate or an organic alkaline aqueous solution such as tetramethylammonium hydroxide, tetraethylammonium hydroxide, tetrabutylammonium hydroxide, monoethanolamine, diethanolamine or triethanolamine can be used.

The epoxy resin composition, the epoxy resin composition and a cured product thereof of the present invention can be used for various purposes including materials of optical parts. Herein, the materials of optical parts refer to general materials through which visible light, infrared rays, ultraviolet rays, X rays or lasers pass. Specific examples of articles using such a material include sealing materials for lamp type or SMD type LEDs and the following. In the field of display devices, examples of such articles include liquid crystal display device-related materials such as substrate materials, light guide plates, prism sheets, deflecting plates, retardation plates, viewing angle correction films, adhesives and films for liquid crystals such as polarizer protection films in the field of liquid crystal displays, sealing materials, antireflection films, optical compensation films, housing materials, front glass protection films, front glass alternative materials and adhesives for color PDPs (plasma display) which are expected to be next-generation flat panel displays, LED molding materials, LED sealing materials, front glass protection films, front glass alternative materials and adhesives which are used in LED display devices, substrate materials, light guide plates, prism sheets, deflecting plates, retardation plates, viewing angle compensation films, adhesives and polarizer protection films in plasma address liquid crystal (PALC) displays, front glass protection films, front glass alternative materials and adhesives in organic EL (electroluminescent) displays, and various film substrates, front glass protection films, front glass alternative materials and adhesives for field emission displays (FEDs). Besides, in the field of optical recording, examples of articles include VD (video disks), CD/CD-ROM, CD-R/RW, DVD-R/DVD-RAM, MO/MD, PD (phase change disks), disk substrate materials for optical cards, pick-up lenses, protective films, sealing materials and adhesives.

In the field of optical equipment, examples include lens materials, finder prisms, target prisms, finder covers and light receiving sensors of still cameras, taking lenses and finders of video cameras, projector lenses, protective films, sealing materials and adhesives for projection TVs and lens materials, sealing materials, adhesives and films for optical sensing devices. In the field of optical parts, examples of articles include optical switch-related fiber materials, lenses, waveguides, sealing materials of devices and adhesives, and optical connector-related optical fiber materials, ferrules, sealing materials and adhesives in optical communication systems. Further, in optical passive elements and optical circuit elements, examples of articles include lenses, waveguides, LED sealing materials, CCD sealing materials and adhesives, and optoelectronic integrated circuit (OEIC)-related substrate materials, fiber materials, sealing materials of devices and adhesives. In the filed of optical fiber, examples of articles include illumination and light guides of decorative displays, industrial use sensors, displays, indicators and optical fiber for communication infrastructure or for connecting domestic use digital devices. In semiconductor integrated circuit-related materials, examples of articles include resist materials of LSI or VLSI in microlithography. Examples of next-generation optoelectronic functional organic materials include organic EL element-related materials, organic photorefractive elements, optical amplifying elements which are light-light conversion devices, optical computing elements, and organic solar cell-related substrate materials, fiber materials, sealing materials of elements and adhesives. In addition to these optical material uses, examples of articles also include, in the field of automobiles and transportation vehicles, automobile lamp reflectors, bearing retainers, gear parts, anticorrosion coat, switching parts, head lamps, engine internal parts, electrical parts, various interior and exterior parts, driving engines, brake oil tanks, automobile antirust steel plates, interior panels, interior materials, protective and binding wire harnesses, fuel hoses, automobile lamps, glass alternative materials, double glass for railway vehicles, and toughness-imparting agents for structural materials, engine-related materials, protective and binding wire harnesses and anticorrosion coat in aircraft. In the architectural field, examples of articles include interior and processing materials, lamp shades, sheets, glass intermediate films, glass alternative materials and solar cell related materials. In the agricultural field, examples of articles include cover films for greenhouses.

Further, examples of uses also include general uses in which a thermosetting resin such as an epoxy resin is used, such as adhesives, coatings, coating agents, molding materials (including sheet, films and FRP), insulating materials (including printed substrates and wire coatings), sealing materials and additives to other resins.

Examples of adhesives include adhesives for construction, architecture, automobiles, offices, medical care and electronic materials. Of these, examples of adhesives for electronic materials include interlayer adhesives for multi-layer substrates such as build-up substrates, die bonding agents, semiconductor adhesives such as underfills, BGA reinforcing underfills and packaging adhesives such as anisotropic conductive films (ACF) and anisotropic conductive pastes (ACP).

### EXAMPLES

The present invention is now described in more detail by means of Examples. “Part(s)” in the following means “part(s) by weight” unless otherwise specified. Softening points and epoxy equivalents are measured under the following conditions.

Melting Point: DSC method

EXSTAR 6000 made by Seiko Instruments Inc.

Measurement sample: 2 mg to 5 mg

Temperature increasing rate: 10° C./min.

Epoxy Equivalent

Measured in accordance with the method described in JIS K-7236. The unit is g/eq.

### Example 1

A flask equipped with a thermometer, a cryostat tube and a stirrer was charged with 169 parts of the compound of the formula (1) (DOQ-O available from Sanko Chemical Industry Co., Ltd.), 463 parts of epichlorohydrin and 169 parts of methanol with performing nitrogen gas purge, and the components were dissolved. After heating to 70° C. and adding thereto 41 parts of flaky sodium hydroxide in installments over 90 minutes, the mixture was reacted at 70° C. for additional 60 minutes. After completion of the reaction, washing was performed with 150 parts of water twice to remove the resulting salt. Then, excess epichlorohydrin was evaporated in 3 hours by heating and stirring under reduced pressure (to 70° C. at −0.08 MPa to −0.09 MPa). When a slurry was formed, the pressure was released and 300 parts of acetone was added thereto. After stirring for 30 minutes in a reflux state, 1500 parts of methanol was added thereto, and the mixture was stirred for 15 minutes and then 300 parts of water was gradually added. The intended crystalline epoxy resin was prepared by filtering the solution under reduced pressure. By sufficiently washing the crystal with 200 parts of methanol and 200 parts of water and drying, 191 g of the epoxy resin of the present invention was prepared in the form of white powder crystal (the crystal is referred to as D-1). The resulting epoxy resin has an epoxy equivalent of 242 g/eq and a melting point of 98° C. As a result of measuring the refractive index, the epoxy resin has a refractive index of 1.65. (The resin was dissolved in dimethyl sulfoxide and the refractive index was measured at three points and subjected to calculation; measurement apparatus: multiwavelength Abbe refractometer DR-M2 made by ATAGO CO., LTD., measurement wavelength: 589 nm (D ray))

### Comparative Example 1

A flask equipped with a thermometer, a cryostat tube and a stirrer was charged with 169 parts of the compound of the formula (1) (DOQ-O available from Sanko Chemical Industry Co., Ltd.), 555 parts of epichlorohydrin and 110 parts of DMSO with performing nitrogen gas purge, and the components were dissolved. After heating to 40° C. and adding thereto 41 parts of flaky sodium hydroxide in installments over 90 minutes, the mixture was reacted at 50° C. for 2 hours and 70° C. for 1 hour. After completion of the reaction, washing was performed once with 150 parts of water to remove the resulting salt. Then, excess epichlorohydrin was removed from the oil layer by heating under reduced pressure, and the residue was dissolved in 450 parts of methyl isobutyl ketone. The solution was heated to 70° C. and 7 parts of a 30% by weight aqueous sodium hydroxide solution was added thereto to perform the reaction for an hour. The resultant was washed with water until the washing liquid became neutral and methyl isobutyl ketone and other components were evaporated from the oil layer by heating under reduced pressure to give 207 parts of an epoxy resin for comparison. The epoxy resin is a light yellow solid resin having an epoxy equivalent of 234 g/eq. and a softening point of 63° C. (the resin is referred to as D-2).

### Example 2

### Synthetic Example

A 3 L flask equipped with a stirrer and a reflux tube was charged with 860.0 g of EOCN-103S available from NIPPON KAYAKU CO., LTD. (multifunctional cresol novolak epoxy resin, epoxy equivalent: 215.0 g/eq) as the epoxy compound (a) containing two or more epoxy groups in the molecule, 288.3 g of acrylic acid (molecular weight: 72.06) as the monocarboxylic acid compound (b) containing an ethylenically unsaturated group in the molecule, 492.1 g of carbitol acetate as a reaction solvent, 4.921 g of 2,6-di-tert-butyl-p-cresol as a thermal polymerization inhibitor and 4.921 g of a triphenylphosphine as a reaction catalyst. The mixture was reacted until the reaction solution had an acid value of 0.5 mg·KOH/g or less at 98° C. to give an epoxy carboxylate compound.

Then, 169.8 g of carbitol acetate was added to the reaction solution as a reaction solvent and 201.6 g of tetrahydrophthalic anhydride as the polybasic acid anhydride (c). The mixture was reacted at 95° C. for 4 hours to give a resin solution containing an alkaline aqueous solution soluble resin (A) at a concentration of 67% by weight (the solution is referred to as A-1). The acid value of the solution was measured to be 69.4 mg·KOH/g (solid content acid value: 103.6 mg·KOH/g).

### Example 3, Comparative Example 2

Resin solution (A-1) prepared in Example 2, epoxy resin (D-1) prepared in Example 1 and epoxy resin (D-2) prepared in Comparative Example 1 were mixed at a ratio described on Table 1. The mixture was kneaded with a three roll mill to give the epoxy resin composition of the present invention. The resin composition was applied to a printed board of about 10 cm square by screen printing in a dried film thickness of 15 to 25 μm and the coating film was dried in a hot air dryer at 80° C. for 30 minutes. Subsequently, the coating film was irradiated with ultraviolet rays through a mask on which a circuit pattern was drawn using ultraviolet exposure equipment (ORC MANUFACTURING CO., LTD. Model HMW-680GW). Then, the pattern was developed by spraying with a 1% aqueous sodium carbonate solution to remove resin portions which were not irradiated with ultraviolet rays. After water washing and drying, the printed board was subjected to heat curing reaction in a hot air drier at 150° C. for 60 minutes to give a cured film. The results are shown on Table 2. The test methods and evaluation criteria are as follows.

### (Tacking Properties)

An absorbent cotton was rubbed against the film applied to the substrate after drying to evaluate tacking properties of the film.

◯ . . . The absorbent cotton does not stick to the film.

X . . . Strings of absorbent cotton stick to the film.

### (Heat Stability)

Development properties when dried at 80° C. for 40, 50, 60 or 70 minutes were evaluated with the following evaluation criteria.

◯ . . . Ink was completely removed at the time of development and development was successful.

X . . . Some portions were not developed in development.

### (Resolution)

A negative pattern of 50 μm is closely attached to the coating film after drying and exposed by irradiating with ultraviolet rays at an integrated light intensity of 200 mJ/cm². The pattern is then developed with a 1% aqueous sodium carbonate solution for 60 seconds at a spray pressure of 2.0 kg/cm² and the transferred pattern is observed with a microscope. The following criteria were employed.

◯ . . . Pattern edges are straight, suggesting that the resolution is successful.

X . . . Peeling is observed or pattern edges are rough.

### (Photosensitivity)

A step tablet of 21 steps (available from Kodak) is closely attached to the coating film after drying and exposed by irradiating with ultraviolet rays at an integrated light intensity of 500 mJ/cm². The pattern is then developed with a 1% aqueous sodium carbonate solution for 60 seconds at a spray pressure of 2.0 kg/cm². The number of steps in the coating film that remained undeveloped is observed.

### [Table 1]

TABLE 1

| | | | Comparative |
|---|---|---|---|
| | Note | Example 3 | Example 2 |
| Resin solution | | | |
| A-1 | | 51.80 | 51.80 |
| Crosslinking agent (B) | | | |
| DPHA | *1 | 3.38 | 3.38 |
| Photopolymerization initiator (C) | | | |
| IRGACURE 907 | *2 | 4.50 | 4.50 |
| DETX-S | *3 | 0.45 | 0.45 |
| Curing agent (D) | | | |
| D-1 | | 17.62 | |
| D-2 | | | 17.62 |
| Thermosetting catalyst | | | |
| Melamine | | 1.00 | 1.00 |
| Filler | | | |
| Barium sulfate | | 15.15 | 15.15 |
| Phthalocyanine blue | | 0.45 | 0.45 |
| Additive | | | |
| BYK-354 | *4 | 0.39 | 0.39 |
| KS-66 | *5 | 0.39 | 0.39 |
| Solvent | | | |
| CA | | 4.87 | 4.87 |

Note
*1 Dipentaerythritol polyacrylate available from NIPPON KAYAKU CO., LTD.
*2 2-methyl-(4-methylthio)phenyl)-2-morpholino-1-propane available from Vantico
*3 2,4-diethylthioxanthone available from NIPPON KAYAKU CO., LTD.
*4 Leveling agent available from BYK-Chemie GmbH
*5 Defoaming agent available from Shin-Etsu Chemical Co., Ltd.

### [Table 2]

TABLE 2

| | | |
|---|---|---|
| Example | 3 | |
| Comparative Example | | 2 |
| Evaluation items | | |
| Tacking properties | ◯ | X |
| Heat stability | | |
| 40 minutes | ◯ | ◯ |
| 50 minutes | ◯ | ◯ |
| 60 minutes | ◯ | X |
| 70 minutes | ◯ | X |
| Resolution | ◯ | ◯ |
| Photosensitivity | 12 | 11 |

As is evident from the above results, the epoxy resin composition and the cured product of the present invention are highly stable and therefore have excellent heat stability and are highly sensitive because the epoxy resin has good stability in photocuring.

The above results show that the epoxy resin of the present invention has a high refractive index, is crystalline and useful as a material of optical parts. It has also been found that the epoxy resin composition containing the epoxy resin has high storage stability. Accordingly, the cured product of the epoxy resin composition containing the epoxy resin of the present invention is very useful as insulating materials of electric and electronic parts, various composite materials such as laminated boards (printed wiring boards) and CFRP, adhesives, coatings, resist materials, and in particular, for optical uses.

1. A crystalline epoxy resin, wherein said epoxy resin is obtained by reacting a compound represented by the following formula (1): 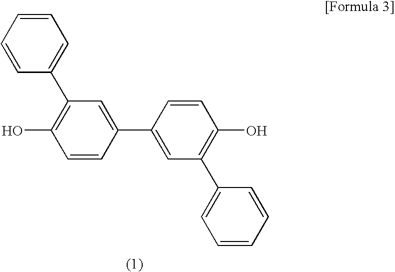
and epihalohydrin.

2. An epoxy resin composition comprising the epoxy resin according to claim 1 and a curing agent for an epoxy resin.

3. An epoxy resin composition comprising the epoxy resin according to claim 1, a compound containing one or more unsaturated double bonds in the molecule and a photopolymerization initiator.

4. A cured product obtained by curing the epoxy resin composition according to claim 2 or 3.

5. An optical material using the epoxy resin composition according to claim 2 or 3.
